(19) United States
(12) Patent Application Publication
(10) Pub. No.: US 2014/0052782 A1
(43) Pub. Date: Feb. 20, 2014

(54) Social Feed Filtering

(71) Applicant: SOLAVEI, LLC, Bellevue, WA (US)

(72) Inventors: James P. Ryan, Bellevue, WA (US); Ryan K. Wuerch, Medina, WA (US)

(73) Assignee: SOLAVEI, LLC, Bellevue, WA (US)

(21) Appl. No.: 13/829,365

(22) Filed: Mar. 14, 2013

Related U.S. Application Data
(60) Provisional application No. 61/683,486, filed on Aug. 15, 2012.

(51) Int. Cl. H04L 29/08

(52) U.S. Cl. CPC H04L 67/306
USPC 709/204

(57) ABSTRACT

Various social feed filtering procedures are described with respect to a social community platform that includes a web service, a feed module, and a feed filtering engine. Social feed members can establish a relevance ranking for each feed item in a group of candidate feed items. The relevance ranking is based on one or more defined social feed criteria. Feed items determined not to be relevant to the social feed criteria can be filtered from the group of candidate feed items, to enable generation of a custom-filtered social feed. Thereafter, the social feed can be presented at a device interface of a computing device. The social feed criteria used to identify the relevance of various feed items may be associated with any of a social community relationship, a social feed topic, member context information, related member interests, or the like.

### PRIORITY APPLICATION(S)

This patent application claims priority filing benefit from U.S. Provisional Patent Application No. 61/683,486, filed Aug. 15, 2012, which is hereby incorporated by reference, in its entirety.

### BACKGROUND

Mobile communication device users can subscribe to, and participate in, many different types of social communities and networks using various modern broadband communication technologies that facilitate relatively high throughput data-rate transfers of vast amounts of Internet protocol (IP) data. Most, if not all, of these social communities typically rely on trust-based relationships between, and amongst, their members to be able to achieve their business objectives. By way of example, social communities available over the Internet are ideal venues for viral marketing, including connection-based advertising and data mining One popular feature existing in a wide variety of web-based social communities and networks is the social feed, which enables affiliated members of the same social community to message each other or post information of interest to a corresponding social feed.

As is generally well-known, a social feed can be associated with a blog space or a news feed, both of which may be driven by underlying HTML or XML pages or documents that include web links to the source of a particular feed content. While news provider websites and web blogs are common sources for feeds, other social communities or networks also use feeds to deliver structured message-based information to, and amongst, their members. At the present time, the two main feed standards employed by most social feeds are RSS (dubbed Really Simple Syndication or Rich Site Summary) and Atom (Atom Syndication is an XML language format).

A problem arises when social feeds become cluttered with large amounts extraneous information, relating to subject matter that does not particularly interest a majority of perusing social feed members. In this regard, more meaningful feed content may be obfuscated by “noise” content. For instance, some location-based or topic-specific feed items are more appropriately directed to a minority of select social feed users, because the majority of social feed users would likely deem this overly focused subject matter to be a nuisance or an “eye-sore.” Disinterested social feed members are often required to manually parse through and scroll past numerous, somewhat obscure (at least from the perspective of the disinterested member) feed content to locate feed items of interest, such as feed content directed to one or more of the social feed member's interests.

### BREIF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example computing environment suitable for providing a social network feed, in accordance with various embodiments described herein.

FIGS. 2-4 illustrate example interfaces of a social feed, which include manual feed filtering options, in accordance with various implementations discussed herein.

FIG. 5 illustrates an example social feed interface suitable for setting social feed filtering preferences, according to various embodiments described herein.

FIG. 6 illustrates a flow diagram process for presenting a filtered social feed, according to various implementations discussed herein.

FIG. 7 illustrates a flow diagram process for creating a custom social feed, in accordance with various embodiments described herein.

FIG. 8 illustrates a flow diagram process for generating a social feed based on relevance ranking assignments, according to various implementations described herein.

FIG. 9 illustrates an example computing system usable to provide a social community platform, according to various embodiments described herein.

FIG. 10 illustrates an example mobile computing device usable in conjunction with a social community platform, according to various embodiments described herein.

### DESCRIPTION OF THE FIGURES

Implementations described within this disclosure are generally directed to a social feed filtering system that can generate custom social feeds including feed items that would be deemed to be relevant to a corresponding social feed member's interests. A social feed can be composed of a thread or string of messages and/or linked content that is posted to the feed by members of an online community, such as by the members of a social e-commerce community. Feed content or feed messages, which are interchangeably referred to herein as “feed items,” may be presented and/or displayed in some logical ordering, such as where a most recent feed item is presented at the top of the social feed, and the oldest feed item is presented at the bottom of the social feed, or in some other sequential presentation fashion.

A social community may include members, groups of members, or entities, which participate in a social transaction system. By way of example, a social commerce community may consist of a community of members or participants whom have signed up for a specific business or utility service, such as a mobile phone service, an energy service, a cable service, a web-based service, or the like. The members of a social commerce community may participate in both offline commerce activities and web-based commerce activities that typically involve the buying and selling of various goods and/or services. In various embodiments, social community members may have the opportunity to recruit additional members into their respective social community.

The recruited members can become part of the recruiting member's extended social community, and in some scenarios, the recruiting member may be compensated by a service provider based on a number of members (service subscribers) that have been recruited into his or her network. Further, in other scenarios, a recruiting member may be directly or indirectly compensated for the commerce-related activities of the recruited members within a social commerce community. These activities may be e-commerce purchases made by affiliated members within their communication network.

In an embodiment, a social community member's affiliated member network can include both members that he or she has directly signed up to participate in the social community, as well as, other members whose membership in the social community can be traced back to another directly affiliated member. For example, a social community member having two levels of separation from a member who was signed up by the member may still be affiliated with the parent member as an indirect recruit. As can be readily inferred from the above description, a social community member's network of affiliated members may include many different relational levels, which can be broken down into network segments, such as a personal network segment and an extended network segment.

In an embodiment, a personal network may include all members determined to be within the first X number of levels (such as the first two levels or the first three levels) from a particular member within his or her social community. Therefore, an extended network may include all other members in the social community, determined not to be within the first X number of levels from the particular member. As noted above, social community members may be compensated by a service provider based on a total number of members present in his or her social community. Members of a social community may further be compensated based on the number of groups within the member's network.

For instance, a member may receive compensation that is based on a number of discrete entity groups that are affiliated with his or her social community. In one scenario, a member may be compensated based on the number of “duos” or “trios” i.e., small groups of two or three related members, that are each affiliated with his or her personal network and/or extended network. Being compensated for a number of groups of related individual affiliated with a member's social community and/or network may provide incentive to the member to assist affiliated members within his or her network in recruiting new entity groups, no matter what the degree of separation is between the indirectly recruited members and the member.

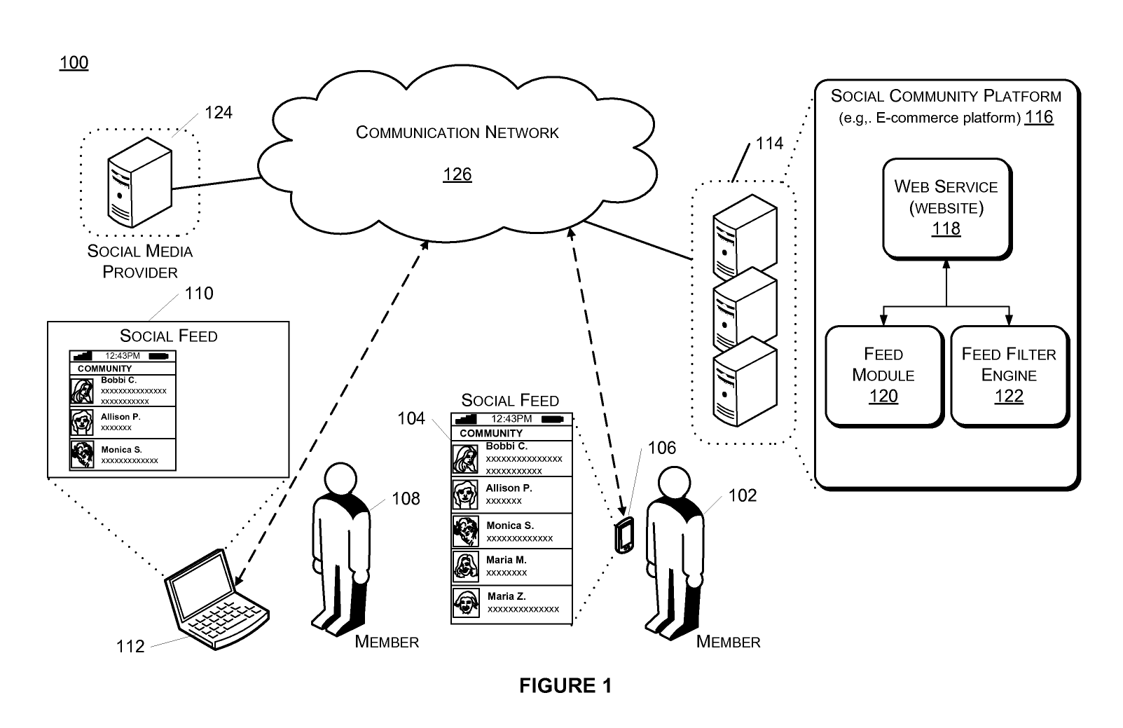

FIG. 1 depicts an example computing environment 100 suitable for providing one or more social feeds, 104 and 110, to members, 102 and 108, of a network-based 126 social community. Various components of the example computing environment 100 may be implemented with any type of suitable computing device, or with any combination of suitable computing devices. By way of example, suitable computing devices can include, but are not limited to, one or more personal computers, server computers, server farms, datacenters, special purpose computers, tablet computers, game consoles, smart phones, cellular phones, media players, as well as any other type of commercially available computing device.

In an embodiment, member 102 may be a social community participant, whom can access a social feed 104 using his or her mobile communication device 106, such a smart phone. Further, member 108 may be a social community participant, whom can access a social network feed 110 using his or her personal computer 112, such as a laptop. In an implementation, the two members, 102 and 108, may subscribe to the same social community, which can be embodied as a web-based entity hosted on one or more servers 114 that are accessible to the members, 102 and 108, via a broadband communication network 126, portions of which may include a 3G or a 4G telecommunication network.

It should be understood that “feed filtering,” as described further herein, may be available to social community members, 102 and 108, both via mobile devices 106 that can employ dynamic, wireless connections to the communication network 126, and via personal computers 112 that may employ static wireline connections to a communication network 126. Further, social feed filtering can be available whether a social feed, 104 and 110, is accessed from a device-side application (e.g., in either an online mode or an offline mode), from a web site service 116 via the Internet, or both. For example many device-side applications can function independent from a broadband network 126 for a period of time; however, these applications generally need to be periodically updated via one or more network access sessions, which are typically only facilitates by Internet communication sessions.

In various implementations, the social feeds, 104 and 110, can enable the members of a social community, 102 and 108, to view messages or feed items from other members of the social commerce community, via a social community platform 116 that can consist of, but is not limited to, a web service component 118, a feed module 120, and a feed filter engine 122. Feed-based messaging can allow members, 102 and 108, to keep apprised of what other members within their particular social community and/or within their social network(s), are doing (e.g., on either a hour-by-hour or day-by-day basis).

In some scenarios, social feed messages may include notifications regarding other social community members' commerce-related activities and/or accomplishments (e.g., their e-commerce purchasing activity, advancements in status/rank, achievement of bonuses for signing up new members, winning of a contest/game, and so forth). In other scenarios, the social feeds, 104 and 110, can enable social community members, 102 and 108, to ask each other questions, post information and/or media of interest (e.g., by linking messages to information and/or media content residing at a social media provider 124), congratulate or motivate one another (e.g., via a “like” or “high-five” indicator), and so forth.

In some implementations, the social feeds, 104 and 110, can enable a member to view all messages from each participant or member of a social community, such as a social commerce community or e-commerce community. However, as a social community expands/grows, a number of messages or feed items presented to a social community member, 102 and 108, in their respective social feed, 104 and 110, may become very large and cluttered; thus making their social feed, 104 and 110, difficult to navigate. For instance, the messages presented to a particular member 102 (e.g., on their device 106) via their social feed 104 may emanate from a relatively large group of geographically diverse individuals, that the particular member 102 may have little or no interest in.

In some scenarios, social feed clutter may be due to situations where: extraneous feed messages emanate from, or are about, other members whom the member 102 does not know (or has a tenuous connection to), feed messages communicate opportunities or advertisements that do not interest the member 102, feed messages communicate information that is not relevant to the member's 102 geographic location, and so forth. Consequently, a social feed, 104 and 110, can include a lot of “noise” that a social community member, 102 and 108, would have to tolerate in order to find information that is relevant to the member's interests. In various embodiments, a feed filter engine 122 of a social community platform 116 may filter social feeds, 104 and 110, in a manner that significantly reduces social feed “noise” or “clutter,” as viewed from the perspective of individual social community members, 102 and 108.

In some implementations, the mobile device 106 or the personal computer 112 may be configured to access a social feed, 104 and 110, via a social community platform 114 that is provided to social community members, 102 and 108, over a communication network 126. In these situation, social feeds, 104 and 110, may be presented at a display of the mobile device 106 or the personal computer 112 via a web service 118 (e.g., via a web service's website) of the social community platform 114. By way of example, the mobile device 106 or the personal computer 112 may include web browsers and/or other software applications, which are configured to acquire web-based information (e.g., HTML, XML, or Java based content) using a web service 118, via a broadband communication network 126 over the Internet.

In various embodiments, the web service 118 of the social community platform 116 may provide various feeds, 104 and 110, to members of a social commerce community, 102 and 108, which are relevant to the members' participation in a social commerce system. The feeds, 104 and 110, may be generated/established by a feed module 120 of the social community platform 116, and the feeds, 104 and 110, may be selectively filtered by a feed filter engine 122 of the social community platform 116. For example, in scenarios where social community members, 102 and 108, post/submit messages and/or feed items to the feed module 120 of the social community platform 116 (e.g., via the web service 118), the feed module 120 can present this feed content to other social community members, 102 and 108, at their respective communication devices, 106 and 112, via the web service 118, in accordance with various feed settings that are applied to the feeds, 104 and 110, by the feed filter engine 122.

In some implementations, the feed filter engine 122 may be configured to filter the social feeds 104 and 110 in various ways, in order to make the social network feed more focused to a particular member's interests, but not in a manner that would be deemed to be overly restrictive. For instance, the member, 102 and 108, may be enabled to select an option that allows him or her to view an expanded list of feed items, including one or more previously filtered feed messages). In some scenarios, the feed filter engine 122 may be configured to sort or modify social feed presentations based on various social relationship criteria, including, but not limited to, a member's social communities and/or social community contacts, individuals within a social community that the member, 102 and 108, has chosen to “follow,” and so forth.

In this regard, filtering based on a member's social community and/or network enables the member, 102 and 108, to view only those feed messages posted by other members within his or her social community and/or network. In some situations, the feed filter engine 122 may enable filtering of a social feed on a more granular or refined level. For example, in some implementations, the feed filter engine 122 may be configured to filter messages from a member's personal contacts, from the member's extended contacts, work contacts, and so forth.

In other embodiments, the feed filter engine 122 may be configured to filter feed items posted by other members within the member's social community that are deemed to be only “one away” from achieving an higher entity group level, relating to a “social distance” between affiliated social community members. This relationship level “closeness,” can enable a social community member to view posted feed messages from other closely affiliated social community members, to communicate more easily with these other members, and to provide motivation to various affiliated social community members to work to achieve a new entity group.

In various embodiments, the feed filter engine 122 may be configured to filter a social feed based, at least in part, on user interests. In some scenarios, user interests may be overtly or explicitly described or listed interests. Alternatively, in other scenarios, member interests may be inferred via observation and analytical insight (e.g., via activity or content pattern-based recognition). In these situations, the feed filter engine 122 may be configured to perform keyword searches on the feed messages to determine whether or not the messages that pertain to the member's interests or the general topic of the feed. In some implementations, a member's interests may be explicitly identified by a member (such as by filling out a checklist or survey) to the feed module 120 of the social community platform 116, or inferred by the feed module 120, from the member's online activities, such as by tracking track of the member's online purchases, web browsing activities, social feed participation, and so forth.

In some situations, the feed filter engine 122 may be configured to filter social feeds based on member context information. Context information may include one or more of a geographic location (e.g., one or more of a home location, a work location, a frequently visited location, a current location based on GPS coordinates or other location information), a time (e.g., a time of day, week, month, year, etc.) or time zone, a type of device being used to access the feed (e.g., there may be a different feed filtering options when a member accesses a social feed using a personal computer versus a mobile phone), and so on. For example, some feeds may be filtered such that only feed items emanating from members located within a certain geographic area (e.g., a geographical area where the member lives or has an address) are presented to the member. In another scenario, a social feed may be filtered to only show messages related to a member's prioritized social community (e.g., their work community), while another social feed may be filtered to present feed items related to the member's prioritized social community, as well as, to present feed items from other social communities that are identified as related to the member's interests.

In other situations, the feed filter 122 may be configured to filter feed items based on a member's friends' activities. For example, the feed filter engine 122 may filter all, or a portion of the, feed items emanating from a member's social community friends or acquaintances. In some embodiments, a social community member's identified “friends” may consist of a subset of members within their social community and/or network, which in some scenarios can even include members located outside the member's locality. In other implementations, the member's friends may be imported or derived from another social community and/or social network provider, such as a social media provider 124, which may be the same as, partially integrated with, or separate from the social community platform 114 providing the social feeds, 104 and 110, to the social community members, 102 and 108.

In various situations, the feed filter engine 122 of the social community platform 116 may be configured to filter feed items based on either manual user selection, or based on automatic feed filtering. Automatic feed filtering may be based, at least in part, on a social community member's recent online activities, most recent manual filtering settings (e.g., filtering settings employed the last time that the member logged onto the web service 118), a user's interests, the member's friends' activities, and so forth. Further, the feed filter engine 122 may be configured to filter feed items based on a wide range of other criteria, including, but not limited to: the type of service consumed by the member (e.g., mobile phone service, cable service, energy service, web-based services, etc.), the member's rank or status within a social community, a compensation level achieved by the member, the related activities of others in the member's social community (e.g., feed items from members achieving significant sales are retained in the social feed, whereas, feed items from other members are filtered out), and so forth.

In various implementations, the feed filter engine 122 may be configured to refer to a member's social community profile to determine social criteria by which to filter a corresponding social feed. For example, one or more of a member's relationship information, contextual information, interest information, type of service consumed information, and so forth, may be saved as part of his or her social community member profile. In some scenarios, member interest information may be inferred by an intelligence engine (not shown) of the social commerce platform 114, which may be a component the feed module 120. The intelligence engine of the feed module 120 may be configured to data mine the member's profile for information related to, or otherwise implying, the member's interests, and subsequently update the member profile with one or more additional inferred interests. The member profile may also be periodically updated with online activity information (e.g., e-commerce purchase activity, web-browsing history, etc.). This member activity information may form the basis for determining one or more inferred member interests.

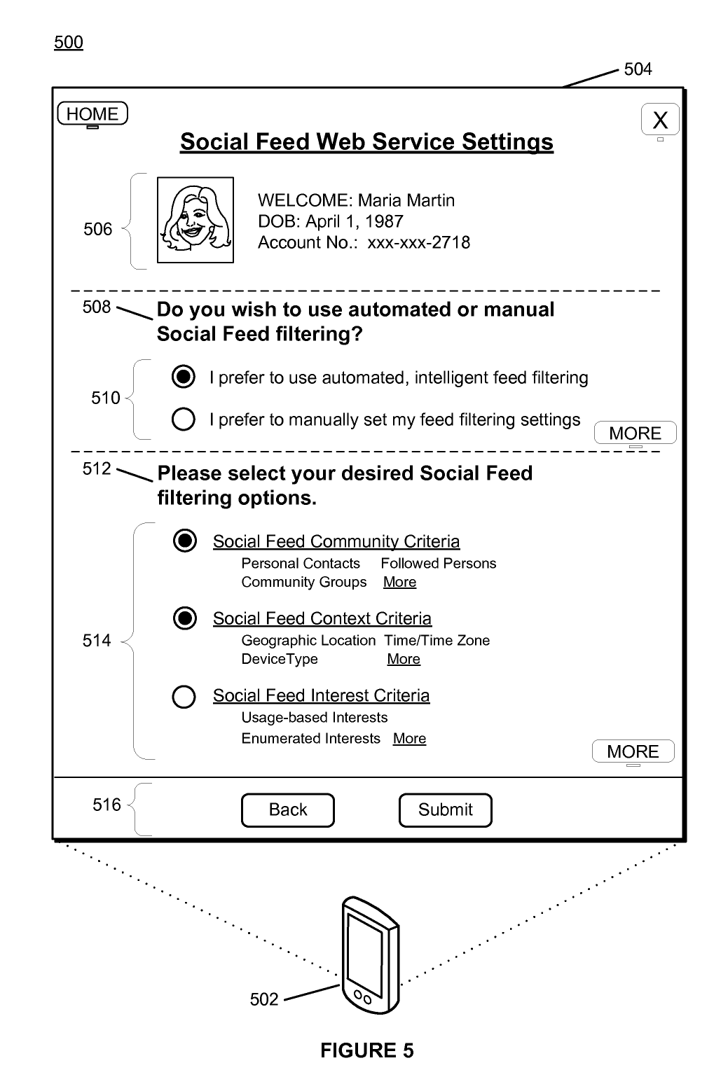

As described herein, various feed filtering operations can be based on more than one criterion, at a time. For example, a social feed may be filtered based on context information as well as relationship information, either automatically or via manual selection (e.g., with a menu-driven interface that allows a member to select one or more feed filtering criteria options, such as is depicted in the interface 504 FIG. 5). It should be understood that some or all of the above-described filtering criteria (as well as any other common filtering criteria) may be applied to a social feed being filtered by the feed filter engine 122, without departing from the scope of the disclosed embodiments.

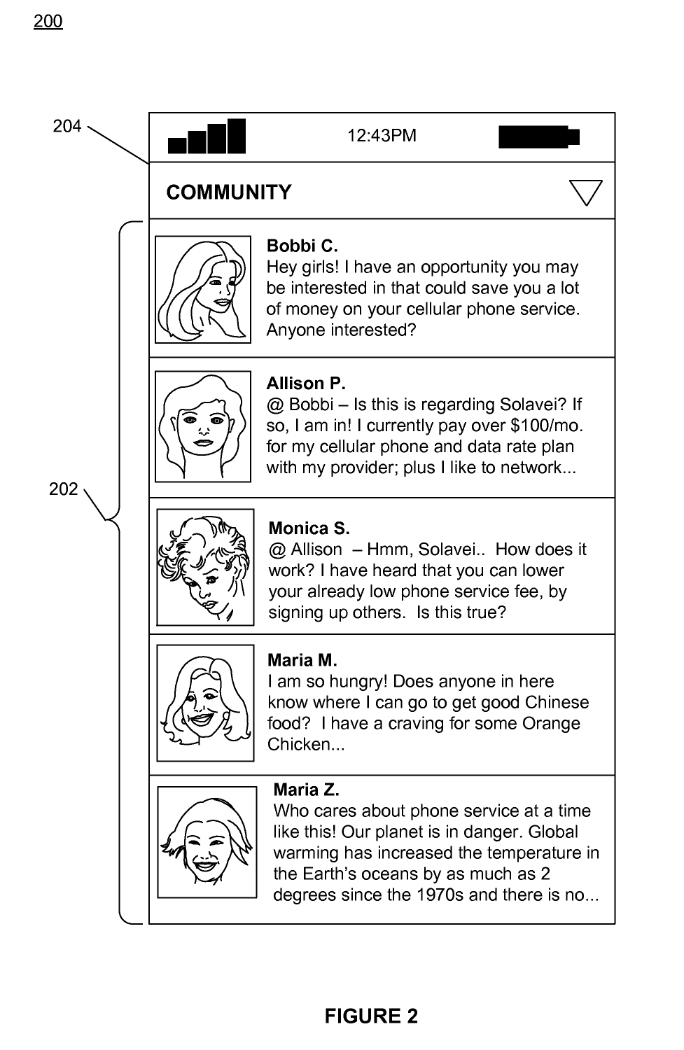

FIGS. 2, 3, and 4, respectively depict example interfaces 200, 300, and 400, for a corresponding social feed 202, 302, and 402, includes various social feed filtering options and/or selections. For example, the social feeds 202, 302, and 402, depicted in FIGS. 2-4 may be the same as, or similar to, the social feeds, 104 and 110, depicted in FIG. 1. In an embodiment, a social feed may be initially set to a “Community” setting (e.g., by default), which can enable a member to view all feed items and/or messages posted by every other member participating in the same social community. However, the member may be enabled to select a different filtering option 204, such as a manual feed filtering option, from the social feed interface 200. Additional social feed filtering options are further described herein with respect to the feed filtering settings interface 504, depicted in FIG. 5.

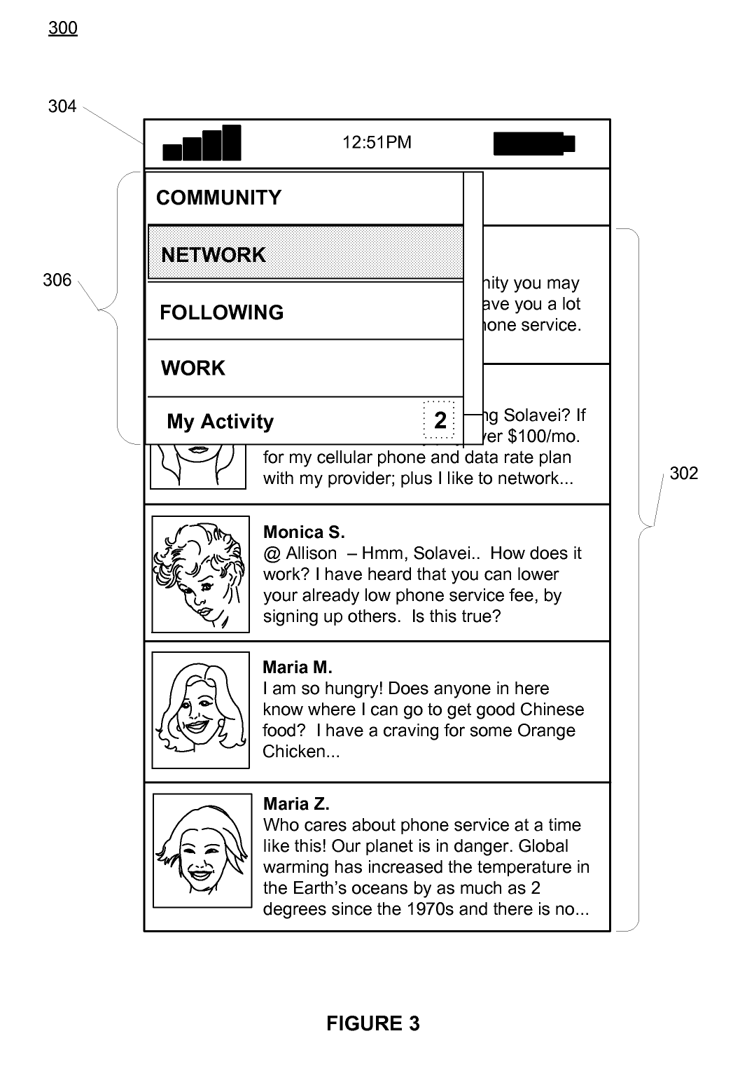

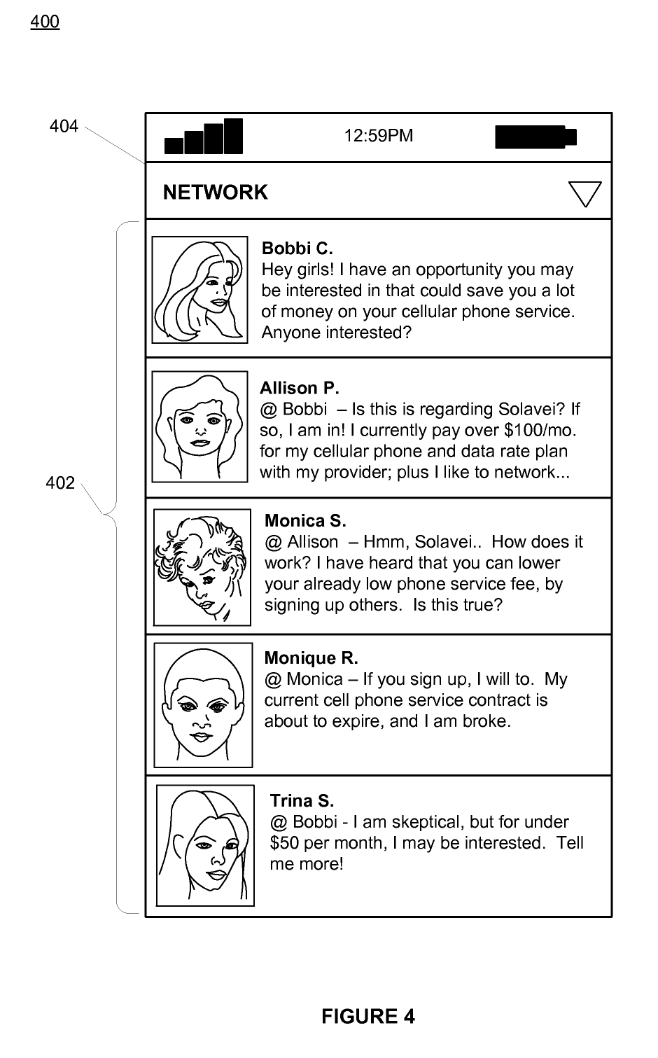

FIG. 3 depicts a social feed interface 300 having a drop-down menu 304 that lists various supplemental feed filtering options, such as a “Network” filtering option 306, which enables filtering the social feed 302 in such a manner as to only present social feed items and/or messages emanating from members within the member's private network, whom may also be members of the same social community. FIG. 4 depicts a social feed 402 that has been filtered based on the network filtering criterion 306 described above, with respect to FIG. 3. In particular, with the “Network” filtering option 404 enabled, the social feed 402 of FIG. 4 presents a pared down version of the social feed 302 depicted in FIG. 3. Notably, various community member feed items from of the Community social feed 302 have been filtered from the Network social feed 402, thereby eliminating various unwanted “noise” (e.g., undesired feed content) from the social feed 402 presentation.

FIG. 5 depicts an example social feed settings environment 500 including a social feed web service settings interface 504 that is presented on the display of mobile device 502, and is suitable for setting social feed filtering preferences, according to various embodiments. The social feed web service to which the settings interface 503 is directed may include, but is not limited to the web service 118 of social community platform 116 described above with respect to the subject matter discussion of FIG. 1. The social feed settings interface 504, may include, but is not limited to, a social community member information area 506 for presenting various information relating to a particular member, i.e., name, date of birth, address, account number, etc., and an automated/manual filtering setting selection area 508 enabling a user to make a selection 510 as to either filter a corresponding feed accordingly to various inferred feed filtering techniques (described herein), or filter a feed according to one or more manually designated feed filtering selections (also described herein).

Further, the social feed settings interface 504 may also include a social feed filtering options area 512, including numerous social feed filtering criteria selections 514, which are selectable by filtering criteria category, or by itemized category sub-criteria. Some examples of social feed filtering criteria include, but are not limited to, social feed community criteria, social feed context criteria, and social feed member interest criteria 514. The social feed community criteria may be comprised of a listing of sub-criteria, which are individually selectable and/or deselectable, and may include, but are not limited to, a personal contacts criterion, a community group criterion, a followed persons criterion, etc. The social feed context criteria may be comprised of a listing of sub-criteria, which are individually selectable and/or deselectable, and may include, but are not limited to, a geographic location criterion, a device type criterion, a time/time zone criterion, etc. Additionally, the social feed member interest criteria may be comprised of a listing of sub-criteria, which are individually selectable and/or deselectable, and may include, but are not limited to, a user-based interest criterion, an enumerated interest criterion, etc.

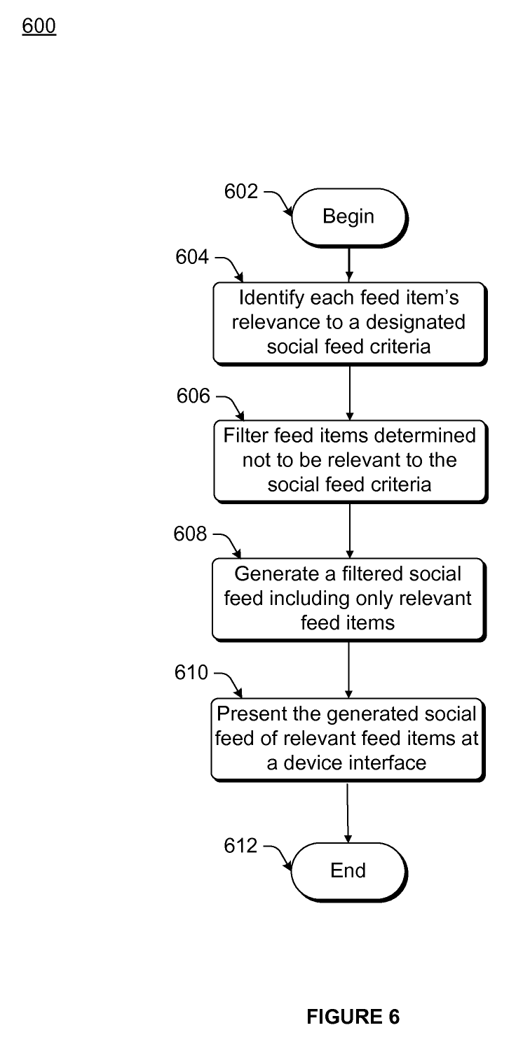

FIG. 6 illustrates a flow diagram process 600 for presenting a filtered social feed, according to various scenarios discussed herein. It should be understood that the procedure 600 may begin at block 602, such as when a social community member attempts to access, load/reload, or establish/generate, a social feed using his or her computing device, such as the mobile device 106 or the personal computer 112. In some implementations, the social feed may only be accessible via a web service 118 of a social community platform 116, at a time when a social community member is connected to a communication network 126, such as the Internet. In other implementations, a cached/stored version of a social feed may be accessible via a software application residing in a memory of a user device, 106 and 112.

At block 604 each feed item (e.g., messages or linked media content) of a particular social feed is identified to determine the respective feed items relevance to various social feed criteria (e.g., any of the social feed community criteria, social feed context criteria, and social feed member interest criteria 514 described above). Then at block 606, after a relevance of each feed item to the designated criteria has been identified, feed items determined not to be relevant to the designated social feed criteria are filtered/removed from a pool of candidate social feed items.

Next, at block 608, a filtered/custom social is generated, which only includes feed items identified as being relevant to the corresponding, designated social feed criteria. By way of example, the social feed 402 of FIG. 4 depicts a filtered social feed, including only a subset of the feed items present in the unfiltered social feed 302 depicted in FIG. 3. At block 610, the generated, filtered social feed is presented at a computing device, such as on display of a mobile communication device. Subsequently, the process 600 ends at block 612.

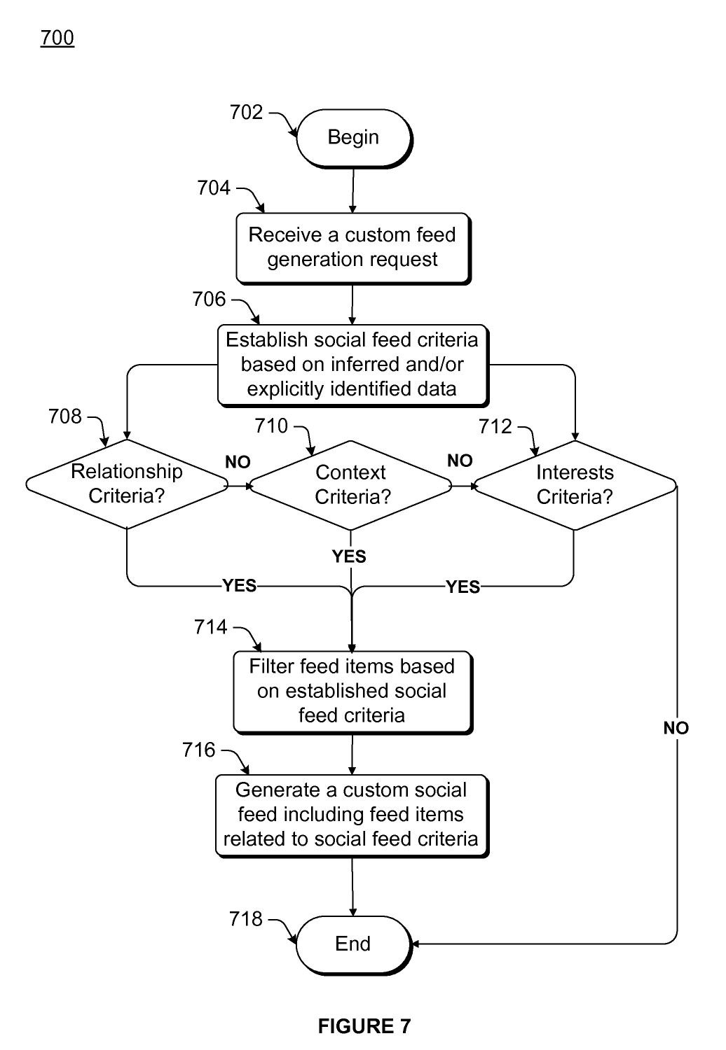

FIG. 7 depicts a flow diagram process 700 for creating a custom social feed, in accordance with various embodiments. It should be understood that the procedure 700 may begin at block 702, such as when a social community member attempts to establish a social feed using his or her computing device. At block 704, a custom social feed generation request is received. Subsequently, various social feed criteria are established based on either inferred data (e.g., data inferred from social community member's activity trends or habits) or explicitly identified data (e.g., data a social community member selects as one or more designated feed filtering criteria, via the feed filtering settings interface 504 of FIG. 5).

In particular, at decision block 708 a determination is made as to whether a social feed is to be filtered in accordance with one or more social community/relationship criteria (described above), at decision block 710 a determination is made as to whether a social feed is to be filtered in accordance with one or more member context criteria (described above), and at decision block 712 a determination is made as to whether the social feed is to be filtered in accordance with one or more member interest criteria (described above). In a scenario where no specific filtering criteria are established, and automatic filtering is not selected, the process ends at block 718.

Alternatively, if one or more of the relationship 708, context 710, and interest 712 criteria are selected as designated filtering criteria, the flow proceeds to block 714, where the social feed is filtered in accordance with the corresponding established/selected social feed criteria. Then, at block 716, a custom social feed is generated, which includes feed items related to established social feed criteria. By way of example, the social feed 402 of FIG. 4 depicts a filtered social feed, including only a subset of the feed items present in the unfiltered social feed 302 depicted in FIG. 3. Subsequently the procedure ends at block 718.

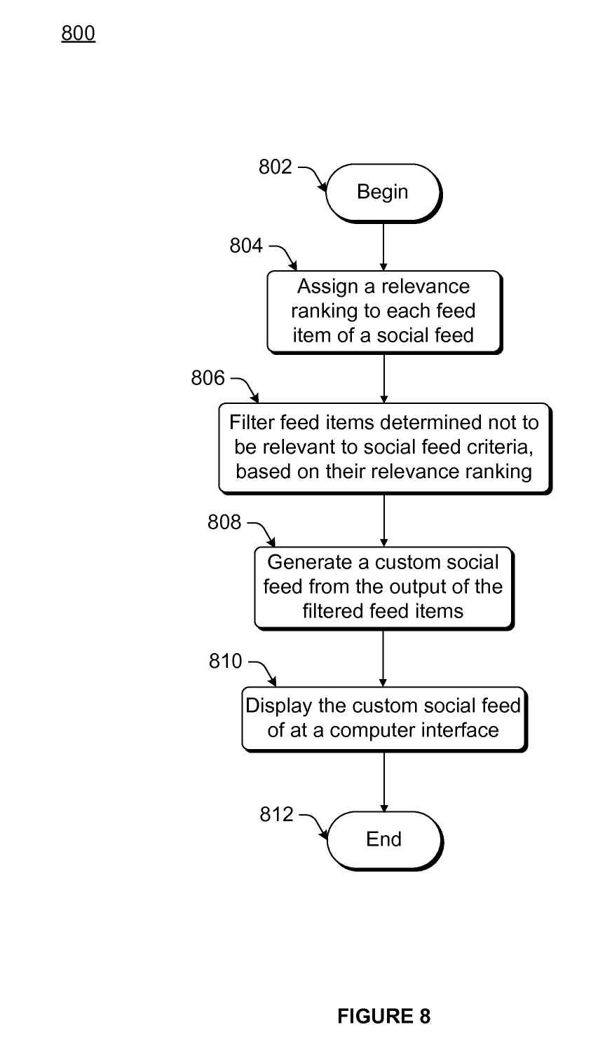

FIG. 8 depicts a flow diagram process 800 for generating a social feed based on relevance ranking assignments, according to various implementations described herein. It should be understood that the procedure 800 may begin at block 802, such as at a time when a social community member attempts to access, load/reload, or establish/generate, a social feed using his or her computing device. At block 804 each social feed item (e.g., messages or linked media content) of a particular social feed is assigned a relevance ranking based, at least in part, on one or more designated social feed filtering criteria (e.g., any of the social feed community criteria, social feed context criteria, and social feed member interest criteria 514 described above).

Then at block 806, after ranking each feed item according to its relevance to the designated social feed filtering criteria, feed items determined to have a substantially lower relevance ranking, in comparison with the other ranked feed items of the social feed, are filtered/removed from a pool of candidate social feed items. Next, at block 808, a custom social is generated from the filtered pool of candidate social feed items, which generally have higher relevance ranking than any of the social feed items that were filtered from the social feed. At block 810, the generated, custom social feed is presented on display of a personal communication device. Subsequently, the process 800 ends at block 812.

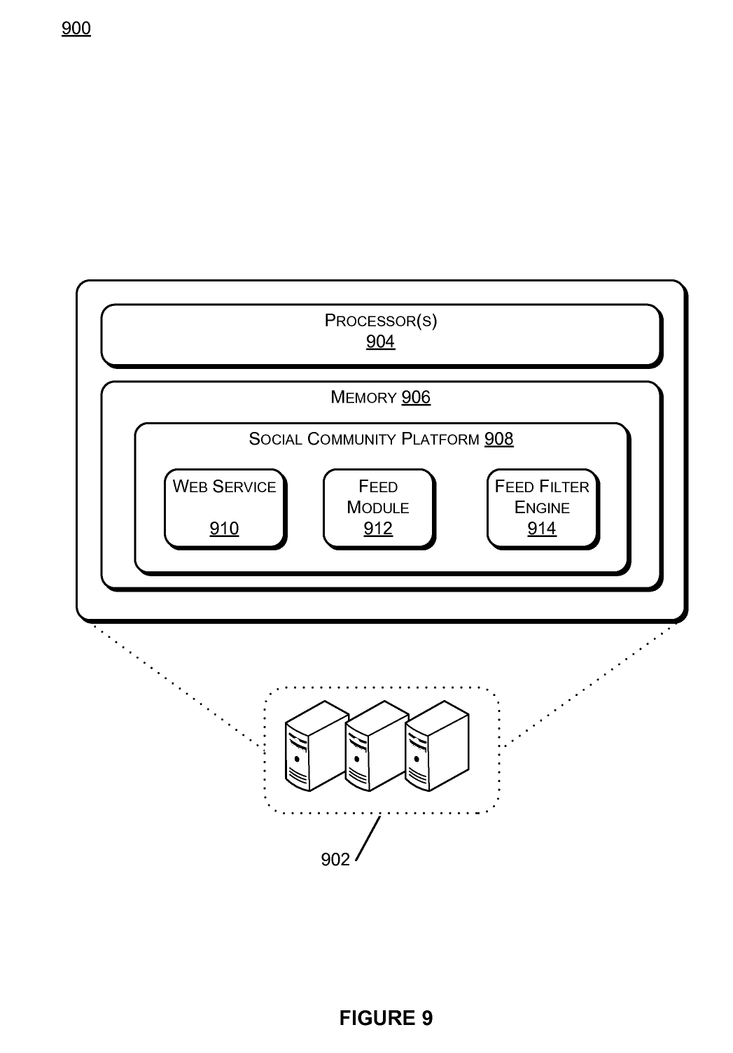

FIG. 9 depicts a block diagram 900 of an example social computing system 902 that is configured to provide a social community platform 906 (which may be representative of the social community platform 114 described above with respect to FIG. 1) that is capable of generating a custom, filtered social feed. In various embodiments, the social community computing system 902 may be included in any suitable type of computing device or group of devices (e.g., operating as a collective entity), which are capable of generating member-specific social feeds. According to various non-limiting examples, suitable computing devices may include, but are not limited to, personal computers, server computers, server farms, datacenters, special purpose computers, tablet computers, game consoles, smart phones, cellular phones, media players, and the like.

The social community computing system 902 may include a memory 906 configured to store program instructions that are loadable and executable by one or more processor(s) 904 of the system 902, as well as data generated during execution of, and/or usable in conjunction with, these programs. For example, the memory 902 may include a social community platform 908, having a web service 910, a feed module 912, and a feed filter engine 914.

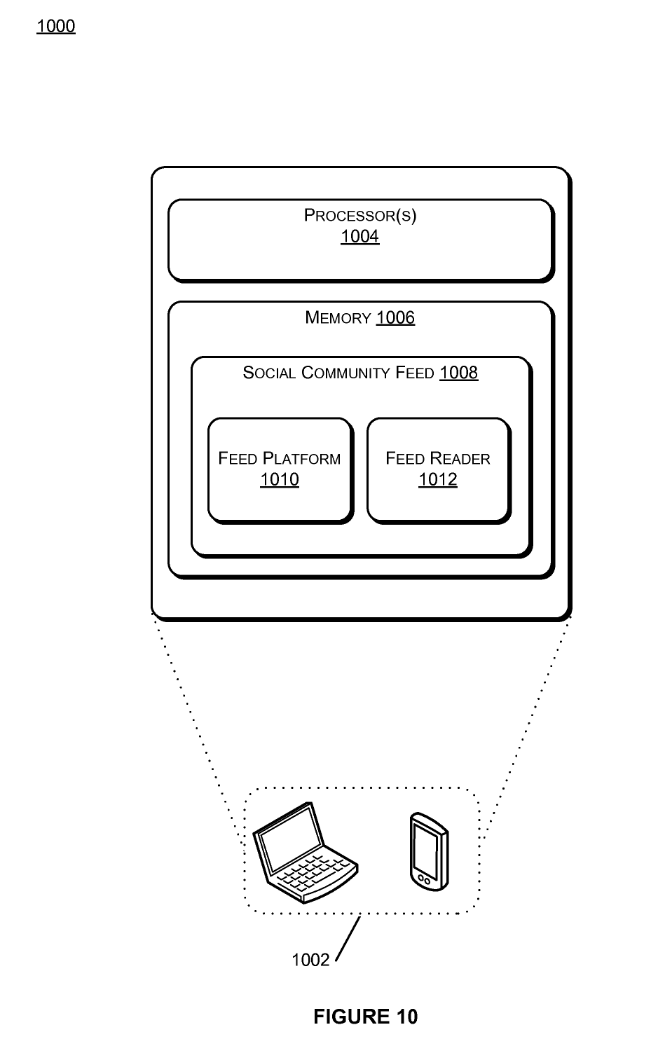

FIG. 10 depicts a block diagram 1000 of an example mobile computing device 1002 usable in conjunction with a community feed platform 1010, according to various embodiments described herein. In an embodiment, the mobile computing device may include, but is not limited to one or more processors 1004 and a memory 1006 configured to store a social feed platform 1008 and/or a feed reader 1010, which may be an optional component in some scenarios. This feed platform 1010 can be linked to the social community platform 902 depicted in FIG. 9, to collaboratively present a dynamic community feed at the mobile computing device via the Internet or some type of local access network.

In various embodiments, the mobile device 1002 may include any suitable type of computing device that is capable of generating and/or presenting a member-specific social feed. According to various non-limiting examples, suitable computing devices may include, but are not limited to, personal computers, server computers, server farms, datacenters, special purpose computers, tablet computers, game consoles, smart phones, cellular phones, media players, and the like.

### Computer-Readable Media

Depending on the configuration and type of computing device(s) used herein, a device memory, 906 and 1006, which may include volatile memory (such as random access memory (RAM)) and/or non-volatile memory (such as read-only memory (ROM), flash memory, etc.). The memory, 906 and 1006, may also include additional removable storage and/or non-removable storage including, but not limited to, flash memory, magnetic storage, optical storage, and/or tape storage that may provide non-volatile storage of computer-readable instructions, data structures, program modules, and other data. The memory, 906 and 1006, is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

Although the disclosure uses language that is specific to structural features and/or methodological acts, the invention is not limited to the specific features or acts described. Rather, the specific features and acts are disclosed as illustrative forms of implementing the invention.

What is claimed is:

1. A computing device, comprising:
one or more processors; and
a memory storing a community feed platform, the community feed platform being executable by the one or more processors to:
identify a relevance of each feed item of a group of candidate feed items based, at least in part, on a social feed criteria;
filter one or more feed items from the group of candidate feed items that is determined not to be relevant to the social feed criteria;
receive a social feed including one or more relevant feed items of the filtered group of candidate feed items; and
present the generated social feed including the one or more relevant feed items at a display of the computing device.

2. The computing device of claim 1, wherein the community feed platform comprises:
a feed module configured to generate the social feed and to allow members to post messages to the social feed;
a feed filter engine configured to generate the social feed in accordance with the social feed criteria; and
a web service configured to present the one or more relevant feed items within the social feed at the device interface of the computing device.

3. The computing device of claim 2, wherein the feed module of the community feed platform is further configured to determine one or more inferred member interests based, at least in part, on a social community member's web-browsing activities, e-commerce activities, social feed participation, or member profile information.

4. The computing device of claim 1, wherein the social feed criteria is associated with one or more of: a social community relationship, a social feed topic, member context information, and member interests.

5. The computing device of claim 1, wherein the relevance of each feed item of the group of candidate feed items is based, at least in part, on a social community relationship associated with one or more of: a member's personal contacts, social community groups, and followed persons of interest.

6. The computing device of claim 1, wherein the relevance of each feed item of the group of candidate feed items is based, at least in part, on member context information associated with one or more of a member's: geographic location, computing device type, and time-of-day information.

7. The computing device of claim 1, wherein the relevance of each feed item of the group of candidate feed items is based, at least in part, on member interests, corresponding to one or more explicitly identified member interests or to one or more inferred member interests.

8. The computing device of claim 1, wherein the community feed platform is further configured to be executed by the one or more processors, in response to a social feed generation request, and to automatically
i) identify the relevance of each feed item in the group of candidate feed items to a social feed, and
ii) filter one or more feed items identified not to be relevant to the social feed.

9. A method, comprising:
identifying, by a computing device, a relevance of each feed item of a group of candidate feed items to a social feed criteria;
filtering, by the computing device, one or more feed items from the group of candidate feed items, which are identified not to be relevant to the social feed criteria; and
generating, by the computing device, a social feed from the filtered group of candidate feed items.

10. The method of claim 9, further comprising presenting, at the computing device, the generated social feed having one or more relevant feed items from the filtered group of candidate feed items.

11. The method of claim 9, wherein the social feed criteria is associated with one or more of: a social community relationship, a social feed topic, member context information, and member interests.

12. The method of claim 9, further comprising identifying the relevance of each feed item of the group of candidate feed items based, at least in part, on a social community relationship associated with one or more of: a member's personal contacts, social community groups, and followed persons of interest.

13. The method of claim 9, further comprising identifying the relevance of each feed item of the group of candidate feed items based, at least in part, on member context information associated with one or more of a member's: geographic location, computing device type, and time-of-day information.

14. The method of claim 9, further comprising identifying the relevance of each feed item of the group of candidate feed items based, at least in part, on member interests, corresponding to one or more explicitly identified member interests or to one or more inferred member interests.

15. The method of claim 9, further comprising determining one or more inferred member interests based, at least in part, on a social community member's web-browsing activities, e-commerce activities, social feed participation, or member profile information.

16. A non-transitory storage media storing computer-executable instructions, which when executed by one or more processors, performs operations, comprising:
assigning a relevance ranking to each feed item of a group of candidate feed items, wherein the corresponding relevance ranking is based on a social feed criteria;
filtering one or more feed items identified not to be relevant to the social feed criteria from the group of candidate feed items, in accordance with their assigned relevance ranking;
generating a social feed from the filtered group of candidate feed items; and
causing the generated social feed having one or more relevant feed items to be presented at a computer interface.

17. The non-transitory storage media of claim 16, wherein the relevance rankings assigned to the candidate feed items are based, at least in part, on a social community relationship associated with one or more of: a member's personal contacts, social community groups, and followed persons of interest.

18. The non-transitory storage media of claim 16, wherein the relevance rankings assigned to the candidate feed items are based, at least in part, on member context information associated with one or more of a member's: geographic location, computing device type, and time-of-day information.

19. The non-transitory storage media of claim 16, wherein the relevance rankings assigned to the candidate feed items are based, at least in part, on member interests, corresponding to one or more explicitly identified member interests or to one or more inferred member interests.

20. The non-transitory storage media of claim 16, wherein the operations further comprise determining one or more inferred member interests based, at least in part, on a social community member's web-browsing activities, e-commerce activities, social feed participation, or member profile information.
